(19) United States
(12) Patent Application Publication
(10) Pub. No.: US 2014/0255545 A1
(43) Pub. Date: Sep. 11, 2014

(54) METHOD INVOLVING CONTACT BETWEEN GRAIN RAW MATERIAL LIQUID AND YEAST, GRAIN RAW MATERIAL LIQUID AND SPARKLING BEVERAGE

(71) Applicant: SAPPORO BREWERIES LIMITED, Shibuya-ku (JP)

(72) Inventors: Yoichi Kozaki, Shibuya-ku (JP); Shigeki Araki, Shibuya-ku (JP); Yuta Katayama, Shibuya-ku (JP)

(73) Assignee: SAPPORO BREWERIES LIMITED, Shibuya-ku (JP)

(21) Appl. No.: 14/351,301

(22) PCT Filed: Oct. 19, 2012
(86) PCT No.: PCT/JP2012/077137

§ 371 Date: Apr. 11, 2014

(30) Foreign Application Priority Data
Oct. 25, 2011 (JP) 2011 234402

(51) Int. Cl. C12C 11/09

(52) U.S. Cl. CPC C12C 11/09
USPC 426/16; 426/592

(57) ABSTRACT

A method including bringing a grain raw material liquid into contact with a yeast to effectively improve foam properties of a sparkling beverage, a grain raw material liquid, and a sparkling beverage are provided. The method includes bringing a first grain raw material liquid into contact with a yeast to produce a second grain raw material liquid to be used for production of a sparkling beverage. The yeast may be an inactivated yeast. The method may further include producing the sparkling beverage using the second grain raw material liquid.

### TECHNICAL FIELD

The present invention relates to a method including bringing a grain raw material liquid into contact with a yeast, a grain raw material liquid, and a sparkling beverage, and more particularly, to improvement of foam properties of a sparkling beverage produced using a grain raw material liquid.

### BACKGROUND ART

Hitherto, as a method of improving foam properties of a sparkling beverage, there has been a method involving externally adding a component that improves the foam properties (see, for example, Patent Literature 1).

### CITATION LIST

### Patent Literature

[Patent Literature 1] JPH 08-502641 A

### SUMMARY OF INVENTION

### Technical Problem

However, in production of the sparkling beverage, there have been some cases where an addition of the component that improves the foam properties is not necessarily preferred, or where the addition of only the component is not necessarily effective.

The present invention has been made in view of the above-mentioned problems, and one of the objects of the present invention is to provide a method including bringing a grain raw material liquid into contact with a yeast to effectively improve foam properties of a sparkling beverage, a grain raw material liquid, and a sparkling beverage.

### Solution to Problem

In order to solve the above-mentioned problems, according to one embodiment of the present invention, there is provided a method, including bringing a first grain raw material liquid into contact with a yeast to produce a second grain raw material liquid to be used for production of a sparkling beverage. According to one embodiment of the present invention, a method of effectively improving foam properties of a sparkling beverage is provided.

Further, the yeast may be an inactivated yeast. Further, the method may include bringing the first grain raw material liquid into contact with the yeast to produce the second grain raw material liquid that improves foam properties of the sparkling beverage compared to the first grain raw material liquid which has not been brought into contact with the yeast.

Further, the method may include: producing a plurality of preliminary sparkling beverages using a plurality of preliminary grain raw material liquids obtained by bringing the first grain raw material liquid into contact with the yeast under a plurality of different conditions to evaluate foam properties of the plurality of preliminary sparkling beverages; determining, based on a result of the evaluation of the foam properties, a condition for bringing the first grain raw material liquid into contact with the yeast to obtain a grain raw material liquid that improves the foamproperties of the sparkling beverage compared to the first grain raw material liquid which has not been brought into contact with the yeast; and bringing the first grain raw material liquid into contact with the yeast under the determined condition to produce the second grain raw material liquid.

Further, the method may further include producing the sparkling beverage using the second grain raw material liquid. In this case, the method may include producing the sparkling beverage using the second grain raw material liquid, the sparkling beverage having improved foam properties compared to a sparkling beverage produced using the first grain raw material liquid which has not been brought into contact with the yeast.

In order to solve the above-mentioned problems, according to one embodiment of the present invention, there is provided a method of improving foam properties of a sparkling beverage produced using a grain raw material liquid, the method including using a second grain raw material liquid obtained by bringing a first grain raw material liquid into contact with a yeast to improve the foam properties of the sparkling beverage as compared to a case of using the first grain raw material liquid which has not been brought into contact with the yeast. According to one embodiment of the present invention, a method of effectively improving foam properties of a sparkling beverage is provided.

Further, in the method, the yeast may be an inactivated yeast.

In order to solve the above-mentioned problems, according to one embodiment of the present invention, there is provided a grain raw material liquid, which is produced by any one of the above-mentioned methods. According to one embodiment of the present invention, a grain raw material liquid that effectively improves foam properties of a sparkling beverage is provided.

In order to solve the above-mentioned problems, according to one embodiment of the present invention, there is provided a sparkling beverage, which is produced by any one of the above-mentioned methods. According to one embodiment of the present invention, a sparkling beverage that has effectively improved foam properties is provided.

### Advantageous Effects of Invention

According to one embodiment of the present invention, a method including bringing a grain raw material liquid into contact with a yeast to effectively improve foam properties of a sparkling beverage, a grain raw material liquid, and a sparkling beverage are provided.

### BRIEF DESCRIPTION OF DRAWINGS

FIG. 1 is an explanatory diagram showing examples of evaluation results of foam properties of sparkling beverages produced using grain raw material liquids that have been brought into contact with yeasts for a plurality of different times in Example 1 according to one embodiment of the present invention.

FIG. 2 is an explanatory diagram showing examples of evaluation results of alcohol contents of grain raw material liquids that have been brought into contact with yeasts for a plurality of different times in Example 1 according to one embodiment of the present invention.

FIG. 3 is an explanatory diagram showing examples of evaluation results of foam properties of sparkling beverages produced using grain raw material liquids that have been brought into contact with yeasts added in a plurality of different amounts in Example 2 according to one embodiment of the present invention.

FIG. 4 is an explanatory diagram showing examples of evaluation results of alcohol contents of grain raw material liquids that have been brought into contact with yeasts added in a plurality of different amounts in Example 2 according to one embodiment of the present invention.

FIG. 5 is an explanatory diagram showing examples of evaluation results of foam properties of sparkling beverages produced using grain raw material liquids that have been brought into contact with yeasts in Example 3 according to one embodiment of the present invention.

FIG. 6 is an explanatory diagram showing examples of evaluation results of foam properties of sparkling beverages produced using grain raw material liquids that have been brought into contact with yeasts for a plurality of different times in Example 4 according to one embodiment of the present invention.

FIG. 7 is an explanatory diagram showing examples of evaluation results of foam properties of sparkling beverages produced using grain raw material liquids that have been brought into contact with yeasts in Example 5 according to one embodiment of the present invention.

FIG. 8 is an explanatory diagram showing examples of evaluation results of foam properties of sparkling beverages produced using grain raw material liquids that have been brought into contact with yeasts in Example 6 according to one embodiment of the present invention.

### DESCRIPTION OF EMBODIMENTS

Hereinafter, a method according to one embodiment of the present invention (hereinafter referred to as “method of the present invention”) is described. It should be noted that the present invention is not limited to this embodiment.

The inventors of the present invention have made intensive studies on a method of improving foam properties of a sparkling beverage. As a result, the inventors themselves have found that the foam properties of the sparkling beverage are effectively improved by using a grain raw material liquid which has been subjected to treatment for contact with a yeast in advance. Thus, the present invention has been accomplished.

The method of the present invention based on such finding by the inventors themselves includes, for example, a method including bringing a first grain raw material liquid into contact with a yeast to produce a second grain raw material liquid to be used for production of a sparkling beverage. That is, in this case, the method of the present invention can also be said to be a method of producing a grain raw material liquid to be used for production of a sparkling beverage.

Therefore, the method of the present invention may be, for example, a method of producing a grain raw material liquid to be used for production of a sparkling beverage, the method including bringing a first grain raw material liquid into contact with a yeast to produce a second grain raw material liquid that improves foam properties of the sparkling beverage as compared to the first grain raw material liquid which has not been brought into contact with the yeast.

That is, when the second grain raw material liquid produced by the method of the present invention is used for production of the sparkling beverage, the second grain raw material liquid effectively improves the foam properties of the sparkling beverage compared to the first grain raw material liquid which has not been brought into contact with the yeast. Herein, the sparkling beverage according to the method of the present invention refers to a beverage having foam properties including foaming property and foam-holding property.

That is, the sparkling beverage is, for example, a beverage containing carbon dioxide gas and having foam-forming property a result of which a foam layer is formed on the top of a liquid when the beverage is poured into a container such as a glass, and foam-stability which allows the formed foam to be held for at least a certain period of time. Therefore, improvement in the foam properties of the sparkling beverage according to the method of the present invention is, for example, improvement in the foam-forming property and/or the foam-stability.

The improvement in the foam-stability of the sparkling beverage means that the once formed foam is held for a longer period of time. Therefore, the improvement in the foam-stability of the sparkling beverage is confirmed by an increase in a NIBEM value of the sparkling beverage.

The NIBEM value is used as an indicator of the foam-stability of a sparkling alcoholic beverage such as beer. The NIBEM value is evaluated as a time (sec) required for a decrease in the height of foam formed by pouring a sparkling beverage in a predetermined container by a predetermined amount. As the NIBEM value becomes larger, the foam-stability of the sparkling beverage becomes more excellent.

It should be noted that the improvement in the foam-stability of the sparkling beverage may also be confirmed by an indicator other than the NIBEM value. That is, the foam-stability of the sparkling beverage may be evaluated by a known method such as a Σ method or a Rudin method.

The sparkling beverage may be a sparkling alcoholic beverage. The sparkling alcoholic beverage is, for example, a sparkling beverage having an ethanol content of 1 vol % or more (having an alcohol content of 1% or more). In this case, the ethanol content of the sparkling alcoholic beverage is not particularly limited as long as the content is 1 vol % or more, and for example, may be from 1 to 20 vol %.

The sparkling beverage may be a sparkling non-alcoholic beverage. The sparkling non-alcoholic beverage is, for example, a sparkling beverage having an ethanol content of less than 1 von. The ethanol content of the sparkling non-alcoholic beverage is not particularly limited as long as the content is less than 1 vol %, and for example, may be 0.05 vol % or less, less than 0.05 vol %, 0.005 vol % or less, or 0.00 vol % or less.

The first grain raw material liquid according to the method of the present invention is not particularly limited as long as the liquid is a solution containing a grain-derived component. The first grain raw material liquid is prepared using grain as at least part of raw materials. That is, the grain raw material liquid is prepared by, for example, mixing grain and water (preferably hot water) to extract a component in the grain. The first grain raw material liquid may be produced without alcoholic fermentation.

The grain to be used for production of the first grain raw material liquid is not particularly limited as long as the grain can be used for production of a beverage. That is, one or more kinds selected from a group consisting of barley, wheat, beans, rice, potato, and corn, and/or germinated products of the one or more kinds may be used as the grain.

Specifically, the first grain raw material liquid may be, for example, a malt liquid containing a malt-derived component. The malt liquid is prepared using malt and/or a malt extract as at least part of raw materials, for example.

As the malt, there may be preferably used barley malt and/or wheat malt. The barley malt and wheat malt are obtained by germinating barley and wheat, respectively. In the case of using the malt as at least part of raw materials, the malt liquid may be the so-called wort.

The wort is prepared by using water and raw materials containing malt. That is, the wort is prepared by mixing at least malt and water (preferably hot water) to extract a component in the malt.

The wort may be prepared by saccharification. In this case, the wort is prepared by, for example, mixing malt and water (preferably hot water) and saccharifying the resultant mixed liquid. The saccharification is carried out by maintaining the mixed liquid including malt and water at a temperature (for example, from 30 to 80° C.) at which a digestive enzyme (such as a starch degrading enzyme or a protein degrading enzyme) in the malt acts. In the case of using hops as part of raw materials, the wort may be prepared by adding hops to a mixed liquid provided by mixing malt and water (for example, a mixed liquid after saccharification) and boiling the resultant.

The malt extract is a composition containing a malt component. That is, the malt extract is, for example, an extract of malt obtained by extraction of malt. In this case, the malt extract is prepared by extraction of malt with water or hot water, for example. The malt extract may be prepared by extraction of malt and the subsequent saccharification. The malt extract may be prepared by concentration after extraction of malt or saccharification.

In the case of using the malt extract as at least part of raw materials, the malt liquid is prepared using a raw material containing the malt extract and water. That is, the malt liquid is prepared by mixing at least the malt extract and water (preferably hot water).

For example, the first grain raw material liquid may be prepared using other grain as at least part of raw materials without using the malt and malt extract. For example, barley and/or wheat or the like (for example, one or more kinds selected from a group consisting of barley, wheat, beans, rice, potato, corn, and any other grain) may be used as grain other than the malt.

The yeast according to the method of the present invention is not particularly limited as long as the yeast can be brought into contact with the first grain raw material liquid, and the yeast can be removed after the contact. For example, an alcohol-producing yeast and/or a non-alcohol-producing yeast may be used as the yeast.

The alcohol-producing yeast is not particularly limited as long as the yeast performs alcoholic fermentation. Specifically, as the alcohol-producing yeast, for example, there may be used one or more kinds selected from a group consisting of beer yeast (for example, bottom fermentation beer yeast and top fermentation beer yeast), wine yeast, shochu yeast, sake yeast, and yeast used for production of bioethanol.

The non-alcohol-producing yeast is not particularly limited as long as the yeast does not perform alcoholic fermentation. Specifically, as the non-alcohol-producing yeast, for example, baker's yeast may be used.

In addition, any of a live yeast and a dead yeast may be used as the yeast as long as the cell body thereof is maintained. That is, the yeast may be a yeast that has been inactivated (hereinafter referred to as “inactivated yeast”). For example, an inactivated alcohol-producing yeast and/or an inactivated non-alcohol-producing yeast is used as the inactivated yeast.

The inactivated yeast may be a killed yeast (hereinafter referred to as “dead yeast”). For example, a dead alcohol-producing yeast and/or a dead non-alcohol-producing yeast is used as the dead yeast. The dead yeast is, for example, a cell body obtained by subjecting a living yeast to one or more treatments selected from a group consisting of thermal treatment, acid treatment, and freezing treatment. In the case where a live yeast is subjected to the thermal treatment, the heating temperature is not particularly limited as long as the live yeast is killed. For example, the dead yeast may be obtained by subjecting the live yeast to the thermal treatment at 100° C. or less, preferably the thermal treatment at less than 80° C. In this case, the heating temperature in the thermal treatment may be, for example, 70° C. or less, 60° C. or less, less than 60° C., or 55° C. or less. The lower limit of the heating temperature is not particularly limited as long as the live cell is killed. The heating temperature is, for example, 30° C. or more, 35° C. or more, or 40° C. or more. It should be noted that the inactivated yeast is not limited to the dead yeast as long as the yeast has been inactivated so that the yeast does not substantially proliferate and/or metabolize.

In the case of using the inactivated yeast, the method of the present invention may be a method of producing a grain raw material liquid without alcoholic fermentation. That is, in this case, in the method of the present invention, for example, a first grain raw material liquid prepared without alcoholic fermentation is brought into contact with an inactivated yeast that does not perform alcoholic fermentation (for example, an inactivated alcohol-producing yeast that has been subjected to artificial treatment (for example, one or more treatments selected from a group consisting of genetic engineering, chemical treatment, and light beam (for example, UV) treatment) and does not substantially perform alcoholic fermentation) to provide a second grain raw material liquid.

As the yeast, a living yeast (hereinafter referred to as “live yeast”) may also be used. The live yeast is a yeast that has not been inactivated. That is, the live yeast is a yeast that performs inherent and normal proliferation and metabolism. Therefore, the live yeast is a yeast that can be used for usual fermentation (alcoholic fermentation and/or non-alcoholic fermentation). For example, a living alcohol-producing yeast and/or a living non-alcohol-producing yeast is used as the live yeast.

In the case of using, as the live yeast, a living non-alcohol-producing yeast that does not substantially perform alcoholic fermentation, the method of the present invention may be a method of producing a grain raw material liquid without alcoholic fermentation as with the case of using the inactivated yeast described above.

In the method of the present invention, the above-mentioned first grain raw material liquid is brought into contact with the above-mentioned yeast to provide the second grain raw material liquid. The second grain raw material liquid is obtained by bringing the first grain raw material liquid into contact with the yeast and then removing the yeast. It should be noted that the method of removing the yeast is not particularly limited, and for example, centrifugation and/or filtration may be used.

The method of bringing the first grain raw material liquid into contact with the yeast is not particularly limited, and for example, there may be used a method involving adding a yeast to a first grain raw material liquid (a method involving dispersing a yeast in a first grain raw material liquid) and/or a method involving allowing a first grain raw material liquid to flow into a container immobilized with a yeast (for example, a container including a carrier immobilized with a yeast).

The condition for the contact of the first grain raw material liquid with the yeast is appropriately determined depending on purposes, such as a characteristic necessary for the second grain raw material liquid and/or a characteristic necessary for the sparkling beverage produced using the second grain raw material liquid.

The condition may be, for example, one or more selected from a group consisting of kind and/or amount of the yeast to be brought into contact with the first grain raw material liquid, temperature and/or time for the contact of the first grain raw material liquid with the yeast, and concentration of an alcohol during the contact of the first grain raw material liquid with the yeast.

Specifically, for example, the first grain raw material liquid may be brought into contact with the inactivated yeast. In this case, the first grain raw material liquid may be brought into contact with the dead yeast. On the other hand, the first grain raw material liquid may be brought into contact with the live yeast.

The yeast may be brought into contact with the first grain raw material liquid in an amount of from 0.01 wt % to 10 wt % (from 0.01 to 10 parts by weight of the yeast are brought into contact with 100 parts by weight of the first grain raw material liquid), for example.

The first grain raw material liquid may be brought into contact with the yeast at a temperature of from −3° C. to 100° C., for example. When the temperature is 100° C. or less, dissolution of the yeast is effectively avoided. The first grain raw material liquid may be brought into contact with the yeast for 0.25 hours or more, for example.

In addition, when the concentration of an alcohol excessively increases during the contact of the first grain raw material liquid with the yeast, there may be a case where the improving effects on foam properties of the sparkling beverage is hard to achieve. Therefore, for example, the first grain raw material liquid may be brought into contact with the yeast so that the concentration of ethanol during the contact of the first grain raw material liquid with the yeast is 5.4 vol % or less.

That is, in this case, the content of ethanol in the second grain raw material liquid obtained by bringing the first grain raw material liquid into contact with the yeast is 5.4 vol % or less. The concentration of ethanol during the contact of the first grain raw material liquid with the yeast is preferably 5.2 vol % or less, more preferably 5.0 vol % or less, even more preferably 1.0 vol % or less.

In addition, the concentration of ethanol during the contact of the first grain raw material liquid with the yeast may be 0.5 vol % or less, 0.3 vol % or less, or 0.1 vol % or less.

The content of ethanol in the second grain raw material liquid can be adjusted by, for example, a condition for the contact of the first grain raw material liquid with the yeast (for example, one or more conditions selected from a group consisting of kind and/or amount of the yeast, and temperature and/or time for the contact with the yeast).

That is, in the method of the present invention, the first grain raw material liquid may be brought into contact with the yeast at a temperature of from 30° C. to 100° C., for example. In this case, for example, the contact of the first grain raw material liquid with the yeast is effectively carried out with effective suppression of alcoholic fermentation of the alcohol-producing yeast by bringing the first grain raw material liquid into contact with the living alcohol-producing yeast at a temperature of from 30° C. to 100° C.

In addition, in the method of the present invention, the first grain raw material liquid may be brought into contact with the yeast at a temperature of from −3° C. to 5° C. Also in this case, the contact of the first grain raw material liquid with the alcohol-producing yeast is effectively carried out with effective suppression of alcoholic fermentation of the living alcohol-producing yeast.

In the method of the present invention, the first grain raw material liquid may be brought into contact with the yeast for 0.25 hour or more and less than 48 hours. In this case, for example, when the time for the contact of the first grain raw material liquid with the living alcohol-producing yeast is adjusted to 0.25 hours or more and less than 48 hours, an increase in the concentration of ethanol is effectively suppressed. The time for the contact of the first grain raw material liquid with the yeast may be from 0.25 hours to 24 hours.

In the method of the present invention, the condition for the contact of the first grain raw material liquid with the yeast to provide the second grain raw material liquid may be determined based on results of a preliminary test in which the first grain raw material liquid is brought into contact with the yeast under a plurality of different conditions.

That is, the method of the present invention is, for example, a method of producing a grain raw material liquid to be used for production of a sparkling beverage, the method including: producing a plurality of preliminary sparkling beverages using a plurality of preliminary grain raw material liquids obtained by bringing the first grain raw material liquid into contact with the yeast under a plurality of different conditions to evaluate foam properties of the plurality of preliminary sparkling beverages; determining, based on a result of the evaluation of the foamproperties, a condition for the contact of the yeast with the first grain raw material liquid to provide a grain raw material liquid that improves the foam properties of the sparkling beverage compared to the first grain raw material liquid which has not been brought into contact with the yeast; and bringing the first grain raw material liquid into contact with the yeast under the determined condition to produce a second grain raw material liquid.

In this case, first, a preliminary test is carried out. In the preliminary test, the first grain raw material liquid is brought into contact with the yeast under a plurality of different conditions (for example, a plurality of conditions different in one or more selected from a group consisting of kind and/or amount of the yeast to be brought into contact with the first grain raw material liquid, temperature and/or time for the contact of the first grain raw material liquid with the yeast, and concentration of alcohol to be achieved during the contact of the first grain raw material liquid with the yeast) to provide a plurality of preliminary grain raw material liquids.

Subsequently, the plurality of preliminary grain raw material liquids are used to produce a plurality of preliminary sparkling beverages. Then, the foam properties of the plurality of preliminary sparkling beverages are evaluated. As a result, the preliminary test provides, for example, correlations between the foam properties of the plurality of preliminary sparkling beverages and the conditions for the contact of the first grain raw material liquid with the yeast to obtain the plurality of preliminary grain raw material liquids used for the plurality of preliminary sparkling beverages, as evaluation results of the foam properties.

Subsequently, the condition for the contact of the first grain raw material liquid with the yeast to produce the second grain raw material liquid that improves the foam properties of the sparkling beverage is determined based on the results of the preliminary test. That is, based on the evaluation results of the foam properties of the preliminary sparkling beverages (for example, the above-mentioned correlations), a condition for obtaining a grain raw material liquid that improves foam properties of a sparkling beverage compared to the first grain raw material liquid which has not been brought into contact with the yeast when the grain raw material liquid is used for production of the sparkling beverage is determined as a condition for the production of the second grain raw material liquid.

More specifically, for example, in a case where the foam-stability (for example, NIBEM values) of the preliminary sparkling beverages are evaluated in the preliminary test, a condition for the contact of the first grain raw material liquid with the yeast to produce a sparkling beverage having excellent foam-stability compared to the foam-stability of a sparkling beverage produced using the first grain raw material liquid which has not been brought into contact with the yeast (for example, a sparkling beverage having a NIBEM value larger than that of a sparkling beverage produced using the first grain raw material liquid which has not been brought into contact with the yeast) is determined.

Then, the second grain raw material liquid is produced under the condition determined as above. That is, the first grain raw material liquid is brought into contact with the yeast under the condition determined as above, and the yeast is then removed to produce the second grain raw material liquid.

According to the method of the present invention, a grain raw material liquid that effectively improves foam properties of a sparkling beverage is produced. That is, the second grain raw material liquid produced by bringing the first grain raw material liquid into contact with the yeast in the method of the present invention effectively improves the foam properties of the sparkling beverage when the second grain raw material liquid is used for production of the sparkling beverage, compared to the first grain raw material liquid which has not been brought into contact with the yeast.

In other words, the foam properties of the sparkling beverage produced using the second grain raw material liquid obtained by the method of the present invention are excellent compared to those of a sparkling beverage produced using the first grain raw material liquid which has not been brought into contact with the yeast.

In addition, the method of the present invention may further include producing the sparkling beverage using the second grain raw material liquid. That is, in this case, the method of the present invention is a method of producing a sparkling beverage using a grain raw material liquid.

Therefore, the method of the present invention may be, for example, a method of producing a sparkling beverage using a grain raw material liquid, the method including using a second grain raw material liquid obtained by bringing a first grain raw material liquid into contact with a yeast to produce a sparkling beverage having improved foam properties compared to a sparkling beverage produced using the first grain raw material liquid which has not been brought into contact with the yeast.

That is, the foam properties of the sparkling beverage produced using the second grain raw material liquid by the method of the present invention are more excellent than those of a sparkling beverage produced using the first grain raw material liquid which has not been brought into with the yeast. Specifically, for example, the NIBEM value of the sparkling beverage produced using the second grain raw material liquid by the method of the present invention may be larger by 5 seconds or more, or 10 seconds or more than that of a sparkling beverage produced using the first grain raw material liquid which has not been brought into contact with the yeast.

The method of producing the sparkling beverage is not particularly limited as long as the method includes using the second grain raw material liquid. That is, the sparkling beverage is produced by, for example, mixing the second grain raw material liquid with other raw material. As the other material, there may be used one or more kinds selected from a group consisting of sugars, dietary fibers, acidulants, pigments, flavors, and sweeteners.

In this case, a sparkling non-alcoholic beverage may be produced as the sparkling beverage. On the other hand, a sparkling alcoholic beverage may be produced using an alcohol (for example, ethanol) as the other raw material.

The sparkling beverage may be produced by diluting the second grain raw material liquid. The method of diluting the second grain raw material liquid is not particularly limited, and for example, may include mixing the second grain raw material liquid and another solution. As the solution, there may be used, for example, one or more kinds selected from a group consisting of water, carbonated water, an alcohol (for example, ethanol), and a liquid additive (for example, one or more kinds selected from a group consisting of sugars, dietary fibers, acidulants, pigments, flavors, and sweeteners).

In this case, a sparkling non-alcoholic beverage may be produced as the sparkling beverage. On the other hand, a sparkling alcoholic beverage may be produced using a solution containing an alcohol (for example, ethanol) as the other solution.

In the method of the present invention, after production of the second grain raw material liquid, the sparkling beverage may be produced using the second grain raw material liquid without alcoholic fermentation. In this case, the first grain raw material liquid prepared without alcoholic fermentation may be used.

In addition, after production of the second grain raw material liquid, a sparkling non-alcoholic beverage may be produced without alcoholic fermentation. On the other hand, after production of the second grain raw material liquid, an alcohol (for example, ethanol) may be added without alcoholic fermentation to produce a sparkling alcoholic beverage.

It should be noted that in a case where the alcoholic fermentation is not performed in the method of the present invention, a method of imparting a sparkling property to the sparkling beverage is not particularly limited, and for example, may include using carbonated water and/or blowing carbon dioxide gas.

According to the method of the present invention, a sparkling beverage having effectively improved foam properties is produced. That is, the foam properties of the sparkling beverage produced using the second grain raw material liquid obtained by the contact of the first grain raw material liquid with the yeast in the method of the present invention are more excellent than those of a sparkling beverage produced using the first grain raw material liquid which has not been brought into contact with the yeast.

Further, the method of the present invention may be, for example, a method of improving foam properties of a sparkling beverage produced using a grain raw material liquid, the method including using a second grain raw material liquid obtained by bringing a first grain raw material liquid into contact with a yeast to improve the foam properties of the sparkling beverage compared to a case of using the first grain raw material liquid which has not been brought into contact with the yeast.

That is, in this case, the method of the present invention is a method of effectively improving the foam properties of the sparkling beverage by using, as the grain raw material liquid to be used for production of the sparkling beverage, the grain raw material liquid that has been brought into contact with the yeast in advance as described above.

Specific examples according to embodiments of the present invention are described below.

### Example 1

First, barley malt was used at a ratio of 100% to prepare wort. That is, hot water at 50° C. was added to pulverized barley malt, and the resultant mixed liquid was maintained at 65° C. to perform saccharification. Further, husks of the barley malt were removed from the mixed liquid after saccharification, and then hops were added thereto, followed by boiling. The mixed liquid after the boiling was obtained as the wort.

On the other hand, a bottom fermentation beer yeast was used as a yeast to be brought into contact with the wort. That is, a living bottom fermentation beer yeast was used as a live yeast without any additional treatment. On the other hand, the living bottom fermentation beer yeast was subjected to thermal treatment to prepare a dead yeast, and the dead yeast was used as an inactivated yeast.

Subsequently, the live yeast or dead yeast was added to the wort in an amount of 1 wt % (1 part by weight of the live yeast or dead yeast relative to 100 parts by weight of the wort). Further, the wort containing the live yeast or dead yeast was maintained at 20° C. for 0.25 hours, 1 hour, 6 hours, 24 hours, or 48 hours to bring the wort into contact with the live yeast or dead yeast.

After that, the yeast was removed from the wort by centrifugation to produce 10 kinds of wort. In addition, for comparison, wort free of contact with the yeast was prepared. Then, the contents of ethanol in the 11 kinds of wort were measured. It should be noted that the contents of ethanol were measured with an alcolyzer.

Further, the 11 kinds of wort were brought into contact with gas containing carbon dioxide (so-called carbonation) to impart sparkling property to the worts, thereby producing 11 kinds of sparkling beverage. Then, the NIBEM values of the 11 kinds of sparkling beverage were measured.

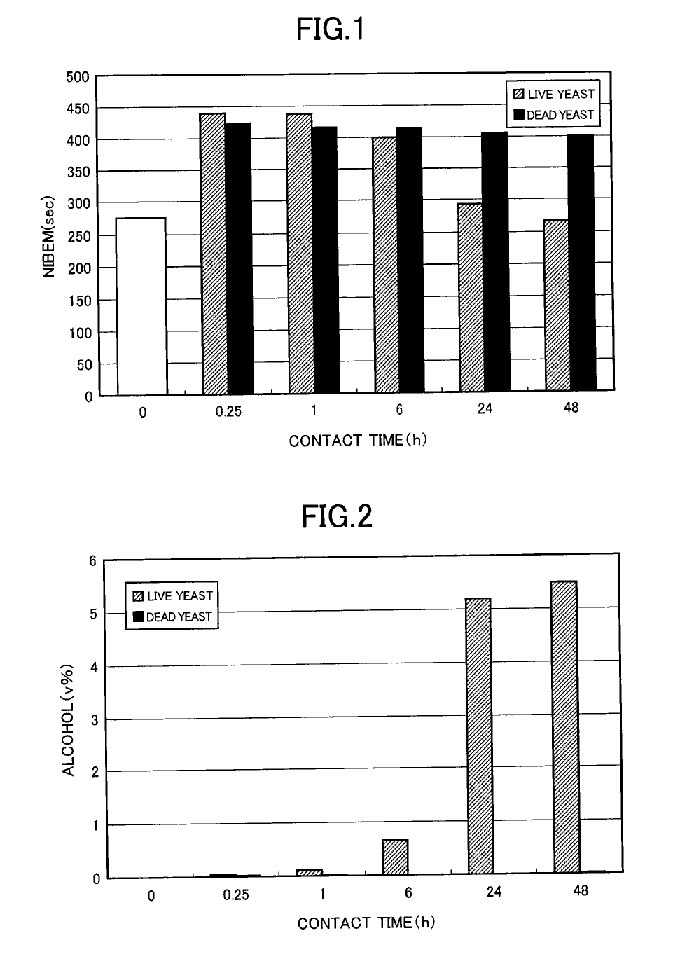

FIG. 1 shows evaluation results of the NIBEM values of the sparkling beverages. In FIG. 1, the horizontal axis (“CONTACT TIME (h)”) represents time for the contact of the worts with the yeasts (time between addition of the yeasts to the worts and removal of the yeasts) (h), and the vertical axis (“NIBEM (SEC)”) represents the NIBEM values (sec) of the sparkling beverages.

FIG. 2 shows evaluation results of the contents of ethanol in the worts used for the production of the sparkling beverages shown in FIG. 1. In FIG. 2, the horizontal axis represents time for the contact of the worts with the yeasts (h), and the vertical axis (“ALCOHOL (v %)”) represents the content (vol %) of ethanol in the worts.

In addition, in FIG. 1 and FIG. 2, hatched bars represent the results in the cases of using the live yeast, solid bars represent the results in the cases of using the dead yeast, and open bars (contact time: zero) represent the results in the cases where the wort has not been brought into contact with the yeast.

As shown in FIG. 1, in the cases of using the live yeast, when the wort that had been brought into contact with the live cells for from 0.25 hours to 24 hours was used, the NIBEM values of the sparkling beverages increased as compared to the cases of using the wort that had not been brought into contact with the live cells. In particular, the NIBEM values significantly increased in the cases of the contact times of less than 24 hours (more specifically from 0.25 hour to 6 hours).

On the other hand, in the case of using the wort that had been brought into contact with the live yeast for 48 hours, the NIBEM value decreased slightly. As shown in FIG. 2, when the live yeast was brought into contact with the wort for 48 hours, the content of ethanol in the wort increased from 0 vol % (contact time: zero) to 5.49 vol %. Therefore, the results suggested that the excessive increase in the content of ethanol suppressed the increase in the NIBEM value.

It should be noted that the contents of ethanol in the wort that had been brought into contact with the live yeast was found to be 5.18 vol % after the contact for 24 hours, 0.67 vol % after the contact for 6 hours, 0.1 vol % after the contact for 1 hour, and 0.04 vol % after the contact for 0.25 hour.

On the other hand, as shown in FIG. 1, in the cases of using the dead yeast, the NIBEM values of the sparkling beverages significantly increased by using the wort that had been brought into contact with the dead yeast for 0.25 hour or more compared to the case of using the wort that had not been brought into contact with the dead yeast.

That is, the improving effects on the foam properties of the sparkling beverages were achieved regardless of life and death of the yeast by using the wort that had been brought into contact with the yeast in advance. Therefore, the effects were inferred to be achieved by a physical and/or chemical interaction between cell body of the yeast (more specifically, for example, molecules present on the surfaces of the cell body) and a component in the first grain raw material liquid.

In addition, as shown in FIG. 2, the content of ethanol in all the worts that had been brought into contact with the dead yeast was found to be 0.03 vol % or less. Therefore, the foam properties of the sparkling beverages were effectively improved while increases in the contents of ethanol in the wort were effectively avoided by using the dead yeast. Ethanol detected in the wort that had been brought into contact with the dead yeast was considered to be derived from a small amount of ethanol that was added together with the dead yeast when the dead yeast was added to the wort.

It should be noted that in this embodiment, the sparkling beverage produced using the wort that had been brought into contact with the dead yeast, the sparkling beverage produced using the wort that had been brought into contact with the live yeast for 6 hours or less, and the sparkling beverage produced using the wort free of contact with the yeast were sparkling non-alcoholic beverages.

### Example 2

First, wort including barley malt at a ratio of 100% was prepared in the same way as in Example 1 above. In addition, a live yeast and a dead yeast were prepared in the same way as in Example 1 above. Subsequently, the live yeast or dead yeast was added to the wort in an amount of 0.1 wt %, 0.5 wt %, 1.0 wt %, 1.5 wt %, or 2.0 wt %. Further, the wort containing the live yeast or dead yeast was maintained at 20° C. for 1 hour to bring the wort into contact with the live yeast or dead yeast.

After that, the yeast was removed from the wort by centrifugation to produce 10 kinds of wort. In addition, for comparison, wort free of contact with the yeast was prepared. Then, the content of ethanol in the 11 kinds of wort was measured.

Further, the 11 kinds of worts were carbonated to produce 11 kinds of sparkling non-alcoholic beverages. Then, the NIBEM values of the 11 kinds of sparkling beverage were measured.

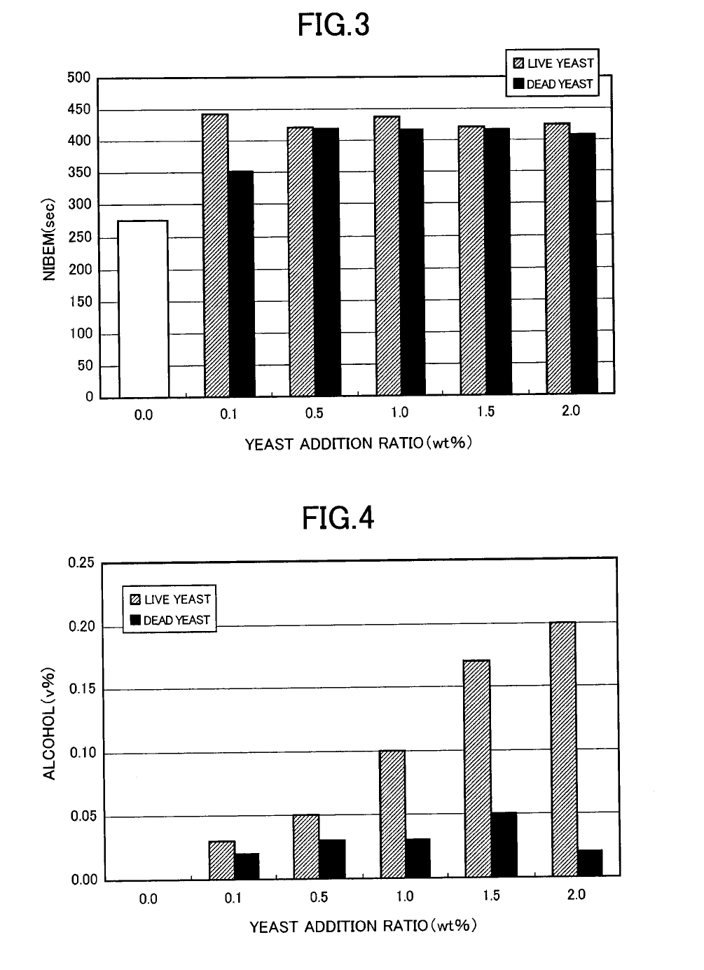

FIG. 3 shows evaluation results of the NIBEM values of the sparkling beverages. In FIG. 3, the horizontal axis (“YEAST ADDITION RATIO (wt %)”) represents the amounts (wt %) of the yeasts brought into contact with the worts, and the vertical axis represents the NIBEM values (sec) of the sparkling beverages.

FIG. 4 shows evaluation results of the contents of ethanol in the worts used for the production of the sparkling beverages shown in FIG. 3. In FIG. 4, the horizontal axis represents the amounts (wt %) of the yeasts brought into contact with the worts, and the vertical axis represents the concentrations (vol %) of ethanol in the worts.

In addition, in FIG. 3 and FIG. 4, hatched bars represent the results in the cases of using the live yeast, solid bars represent the results in the cases of using the dead yeast, and open bars represent the results in the cases where the wort has not been brought into contact with the yeast.

As shown in FIG. 3, in both cases, of using the live yeast and the dead yeast, the NIBEM values of the sparkling beverages significantly increased regardless of the amount of the yeast that had been brought into contact with the wort. In addition, as shown in FIG. 4, the concentration of ethanol in the wort that had been brought into contact with the live cells was 0.2 vol % or less, and the concentration of ethanol in the wort that had been brought into contact with the dead cells was 0.05 vol % or less.

### Example 3

First, barley malt and barley were used to prepare wort. That is, hot water at 50° C. was added to pulverized barley malt and barley (weight ratio: about 1:1), and the resultant mixed liquid was maintained at 65° C. to perform saccharification. Further, husks of the barley malt and barley were removed from the mixed liquid after saccharification, and then hops were added thereto, followed by boiling. The mixed liquid after the boiling was obtained as the wort. In addition, the live yeast and dead yeast were prepared in the same way as in Example 1 above.

Subsequently, the live yeast or dead yeast was added to the wort in an amount of 1.0 wt %. Further, the wort containing the live yeast or dead yeast was maintained at 20° C. for 0.25 hour to bring the wort into contact with the live yeast or dead yeast.

After that, the yeast was removed from the wort by centrifugation to produce 2 kinds of wort. In addition, for comparison, wort free of contact with the yeast was prepared. Further, the 3 kinds of wort were carbonated to produce 3 kinds of sparkling non-alcoholic beverage. Then, the NIBEM values of the 3 kinds of sparkling beverage were measured.

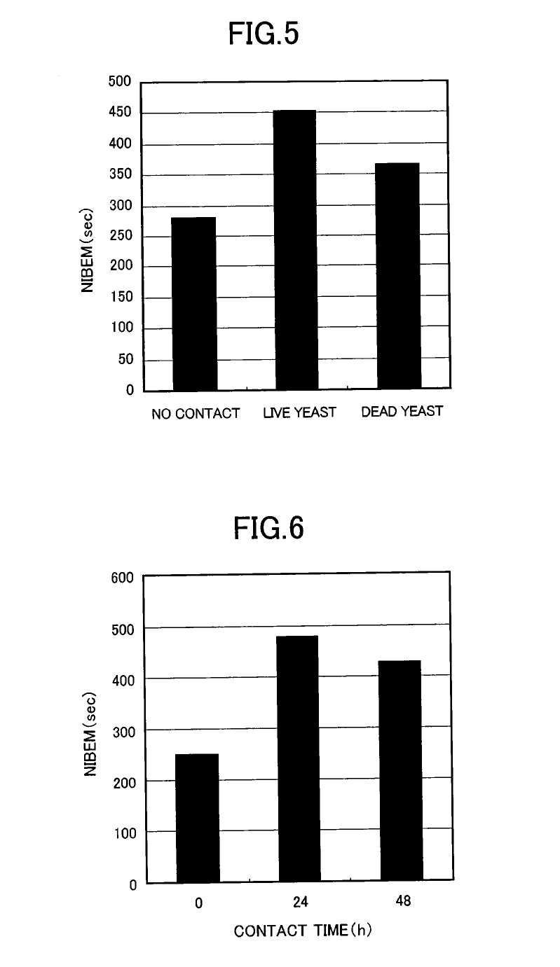

FIG. 5 shows evaluation results of the NIBEM values of the sparkling beverages. That is, FIG. 5 shows the NIBEM values of the sparkling beverage produced using the wort that had not been brought into contact with the yeast (“NO CONTACT”), the sparkling beverage produced using the wort that had been brought into contact with the live yeast (“LIVE YEAST”), and the sparkling beverage produced using the wort that had been brought into contact with the dead yeast (“DEAD YEAST”).

As shown in FIG. 5, in both the cases of using the live yeast and dead yeast, the NIBEM values of the sparkling beverages significantly increased.

### Example 4

First, barley malt and barley were used to prepare wort in the same way as in Example 3 above. In addition, a live yeast was prepared in the same way as in Example 1 above. Then, the live yeast was added to the wort in an amount of 1.0 wt %. Further, the wort containing the live yeast was maintained at 13° C. for 24 hours or 48 hours to bring the wort into contact with the live yeast.

After that, the yeast was removed from the wort by centrifugation to produce 2 kinds of wort. In addition, for comparison, wort free of contact with the yeast was prepared. Further, the 3 kinds of wort were carbonated to produce 3 kinds of sparkling non-alcoholic beverage. Then, the NIBEM values of the 3 kinds of sparkling beverage were measured.

FIG. 6 shows evaluation results of the NIBEM values of the sparkling beverages. That is, FIG. 6 shows the NIBEM values of the sparkling beverage produced using the wort that had not been brought into contact with the yeast (“CONTACT TIME (h)”: “0”), the sparkling beverage produced using the wort that had been brought into contact with the live yeast for 24 hours (“24”), and the sparkling beverage produced using the wort that had been brought into contact with the live yeast for 48 hours (“48”).

As shown in FIG. 6, in both the cases where the wort was brought into contact with the live yeast for 24 hours and 48 hours, the NIBEM values of the sparkling beverages significantly increased by using the wort that had been brought into contact with the live yeast.

### Example 5

First, wort including barley malt at a ratio of 100% was prepared in the same way as in Example 1 above. In addition, a live yeast and a dead yeast were prepared in the same way as in Example 1 above. Subsequently, the live yeast, dead yeast, or yeast extract was added to the wort in an amount of 0.1 wt %. Further, the wort containing the live yeast, dead yeast, or yeast extract was maintained at 20° C. for 1 hour to bring the wort into contact with the live yeast or dead yeast.

After that, the yeast was removed from the wort by centrifugation to produce 2 kinds of wort. In addition, for comparison, wort was prepared by adding yeast extract to wort in an amount of 0.1 wt % and maintaining the resultant at 20° C. for 1 hour. It should be noted that the yeast extract was a composition produced by subjecting a yeast to enzymatic treatment to extract components such as amino acids and nucleic acids in the yeast and removing insoluble components (for example, cell body of the yeast) by separation, the composition including no cell body of the yeast, and mainly included components such as amino acids and nucleic acids extracted from the yeast.

Further, the 3 kinds of wort were carbonated to produce 3 kinds of sparkling non-alcoholic beverage. Then, the NIBEM values of the 3 kinds of sparkling beverage were measured.

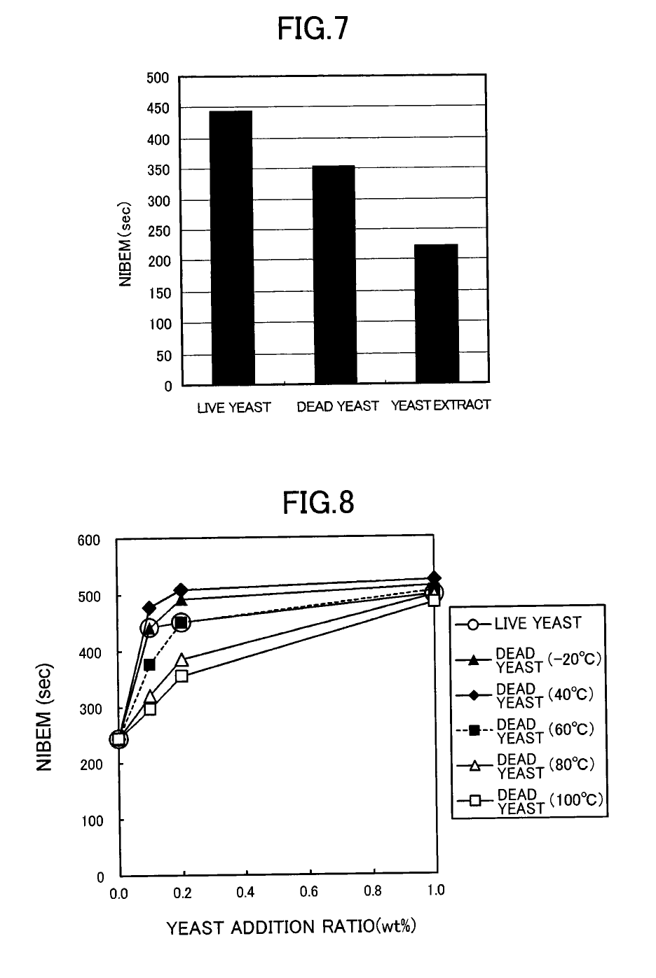

FIG. 7 shows evaluation results of the NIBEM values of the sparkling beverages. That is, FIG. 7 shows the NIBEM values of the sparkling beverage produced using the wort that had been brought into contact with the live yeast (“LIVE YEAST”), the sparkling beverage produced using the wort that had been brought into contact with the dead yeast (“DEAD YEAST”), and the sparkling beverage produced using the wort supplemented with the yeast extract (“YEAST EXTRACT”).

As shown in FIG. 7, in both cases, of using the live yeast and the dead yeast, the NIBEM values of the sparkling beverages significantly increased compared to the case of using the yeast extract. That is, it was found that the improving effects on the foam properties of the sparkling beverage by using the wort that had been brought into contact with the yeast in advance were not achieved by adding soluble components in the cell body of the yeast to the wort, but were achieved by the contact of the cell body itself with the wort.

### Example 6

First, wort including barley malt at a ratio of 100% was prepared in the same way as in Example 1 above. In addition, a live yeast was prepared in the same way as in Example 1 above. In addition, the live yeast was subjected to thermal treatment or freezing treatment to prepare a dead yeast.

That is, the live yeast was subjected to thermal treatment at −20° C., 40° C., 60° C., 80° C., or 100° C. to prepare the dead yeast. Specifically, 1.5 g, 3.0 g, or 15.0 g of the live yeast were suspended in 15 mL of distilled water, and 15 mL of the suspension containing the live yeast were placed in a 100 mL-volume conical flask. The conical flask was maintained in a water bath at 40° C., 60° C., 80° C., or 100° C. for 10 minutes to perform the thermal treatment for the live yeast, thereby providing a suspension containing the dead yeast. On the other hand, the suspension containing the live yeast was maintained in a freezing machine at −20° C. for 21.5 hours to subject the live yeast to the freezing treatment, and the resultant was thawed, thereby providing a suspension containing the dead yeast.

Subsequently, 15 mL of the suspension containing the live yeast or dead yeast were added to 1.5 L of the wort at 4° C. to prepare wort containing the live yeast or dead yeast added in an amount of 0.1 wt %, 0.2 wt %, or 1.0 wt %. Further, the wort containing the live yeast or dead yeast was maintained at 20° C. for 15 minutes to bring the wort into contact with the live yeast or dead yeast.

After that, the yeast was removed from the wort by centrifugation to produce 18 kinds of wort. In addition, for comparison, wort free of contact with the yeast was prepared. Further, the 19 kinds of wort were carbonated to produce 19 kinds of sparkling beverage. Then, the NIBEM values of the 19 kinds of sparkling beverage were measured.

FIG. 8 shows evaluation results of the NIBEM values of the sparkling beverages. In FIG. 8, the horizontal axis (“YEAST ADDITION RATIO (wt %)”) represents the amounts (wt %) of the yeasts brought into contact with the wort, the vertical axis represents the NIBEM values (sec) of the sparkling beverages, the open circles represent the results of the live yeast, the solid triangles represent the results of the dead yeast obtained by the freezing treatment at −20° C., the solid rhombi represent the results of the dead yeast provided by the thermal treatment at 40° C., the solid squares represent the results of the dead yeast provided by the thermal treatment at 60° C., the open triangles represent the results of the dead yeast provided by the thermal treatment at 80° C., and the open squares represent the results of the dead yeast provided by the thermal treatment at 100° C.

As shown in FIG. 8, the NIBEM values of the sparkling beverages produced using the wort that had been brought into contact with the live yeast or dead yeast significantly increased compared to the NIBEM value of the sparkling beverage produced using the wort that had not been brought into contact with the yeast (the value corresponding to the yeast addition ratio of 0.0 wt %).

In addition, the NIBEM values in the cases of using the dead yeasts obtained by the thermal treatment at less than 80° C. (more specifically, 60° C. or less) were higher than those in the cases of using the dead yeasts obtained by the thermal treatment at 80° C. or more.

Further, the NIBEM values in the cases of using the dead yeasts obtained by the thermal treatment at less than 60° C. (more specifically, 40° C. or less) were higher than those in the cases of using the dead yeasts obtained by the thermal treatment at 60° C. or more, and higher than those in the case of using the live yeast.

In addition, the NIBEM values in the case of using the dead yeast obtained by the freezing treatment were almost same as those in the case of using the dead yeast obtained by the thermal treatment at less than 60° C. (more specifically 40° C. or less), higher than those in the cases of using the dead yeasts obtained by the thermal treatment at 60° C. or more, and higher than those in the case of using the live yeast.

1. A method, comprising contacting a first grain raw material liquid with a yeast to produce a second grain raw material liquid for production of a sparkling beverage.

2. The method according to claim 1, wherein the yeast is an inactivated yeast.

3. The method according to claim 1, comprising contacting the first grain raw material liquid with the yeast to produce the second grain raw material liquid imparting improved foam properties to the sparkling beverage compared to a beverage contacted with the first grain raw material liquid.

4. The method according to claim 1, comprising:
producing a plurality of preliminary sparkling beverages with a plurality of preliminary grain raw material liquids obtained by bringing the first grain raw material liquid into contact with the yeast under a plurality of different conditions to evaluate foam properties of the plurality of preliminary sparkling beverages;
determining, based on a result of the evaluation of the foam properties, a condition for bringing the first grain raw material liquid into contact with the yeast to obtain a grain raw material liquid that improves the foam properties of the sparkling beverage compared to the first grain raw material liquid which has not been brought into contact with the yeast; and
the bringing the first grain raw material liquid into contact with the yeast under the determined condition to produce the second grain raw material liquid.

5. The method according to claim 1, further comprising producing the sparkling beverage with the second grain raw material liquid.

6. The method according to claim 5, comprising the producing of the sparkling beverage with the second grain raw material liquid, the sparkling beverage having improved foam properties compared to a sparkling beverage produced with the first grain raw material liquid which has not been brought into contact with the yeast.

7. A method of improving foam properties of a sparkling beverage, the method comprising contacting a sparkling beverage with a second grain raw material liquid obtained by contacting a first grain raw material liquid with a yeast, thereby improving the foam properties of the sparkling beverage compared to a beverage contacted with the first grain raw material liquid.

8. The method according to claim 7, wherein the yeast is an inactivated yeast.

9. A grain raw material liquid, produced by the method of claim 1.

10. A sparkling beverage, produced by the method of claim 1.

11. The method according to claim 2, comprising contacting the first grain raw material liquid with the yeast to produce the second grain raw material liquid imparting improved foam properties to the sparkling beverage compared to a beverage contacted with the first grain raw material liquid.

12. The method according to claim 2, comprising:
producing a plurality of preliminary sparkling beverages with a plurality of preliminary grain raw material liquids obtained by bringing the first grain raw material liquid into contact with the yeast under a plurality of different conditions to evaluate foam properties of the plurality of preliminary sparkling beverages;
determining, based on a result of the evaluation of the foam properties, a condition for bringing the first grain raw material liquid into contact with the yeast to obtain a grain raw material liquid that improves the foam properties of the sparkling beverage compared to the first grain raw material liquid which has not been brought into contact with the yeast; and
the bringing the first grain raw material liquid into contact with the yeast under the determined condition to produce the second grain raw material liquid.

13. The method according to claim 2, further comprising producing the sparkling beverage with the second grain raw material liquid.

14. The method according to claim 13, comprising the producing of the sparkling beverage with the second grain raw material liquid, the sparkling beverage having improved foam properties compared to a sparkling beverage produced with the first grain raw material liquid which has not been brought into contact with the yeast.

15. A grain raw material liquid, produced by the method of claim 1.

16. A sparkling beverage, produced by the method of claim 1.
